(19) United States
(12) Patent Application Publication
(10) Pub. No.: US 2026/0109403 A1
(43) Pub. Date: Apr. 23, 2026

(54) WHEEL CONTROL SYSTEM AND METHOD OF CONTROLLING A WHEEL USING THE SAME

(71) Applicants: HYUNDAI MOTOR COMPANY, Seoul (KR); KIA CORPORATION, Seoul (KR); SEOHAN INNOBILITY CO., LTD., Chungcheongbuk-do (KR)

(72) Inventors: Hyeong Seop Park, Hwaseong-si (KR); Min Sang Seong, Hwaseong-si (KR); Sung Il Kim, Hwaseong-si (KR); Chul Hee Han, Hwaseong-si (KR); Jae Geun Bang, Hwaseong-si (KR)

(73) Assignees: HYUNDAI MOTOR COMPANY, Seoul (KR); KIA CORPORATION, Seoul (KR); SEOHAN INNOBILITY CO., LTD., Chungcheongbuk-do (KR)

(21) Appl. No.: 19/193,554

(22) Filed: Apr. 29, 2025

(30) Foreign Application Priority Data
Oct. 21, 2024 (KR) 10-2024-0144215

(51) Int. Cl. B62D 17/00; B60B 35/10; B60W 10/30; B60W 30/045; B62D 7/18

(52) U.S. Cl. CPC B62D 17/00; B60B 35/1036; B60B 35/1072; B60W 10/30; B60W 30/045; B62D 7/18; B60W 2520/10; B60W 2520/105; B60W 2552/40; B60W 2710/30

(57) ABSTRACT

A wheel control system controls a wheel of a vehicle and includes a knuckle supporting the wheel and controlling a direction of the wheel. The system also includes a wheel control device connected to the knuckle and capable of controlling movement of the knuckle. The wheel control device may be supported on a chassis of the vehicle. The wheel control device may include an actuator arm including a linear actuator.

### CROSS-REFERENCE TO RELATED APPLICATION(S)

This application claims the benefit of and priority to Korean Patent Application No. 10-2024-0144215 filed on Oct. 21, 2024 in the Korean Intellectual Property Office, the disclosure of which is incorporated herein by reference in its entirety.

### BACKGROUND

### 1. Field

The present disclosure relates to a wheel control system and a method of controlling a wheel using the same.

### 2. Description of Related Art

The wheel control system of a vehicle may be a system that allows the driver to control the turning or motion direction of the vehicle or controls the direction and angle at which the wheels are tilted. Various components of the wheel control system may interact with each other to allow the vehicle to move in the direction desired by the driver or to improve the driving performance of the vehicle.

The wheel control system of a vehicle is connected to the right and left wheels of the vehicle. Thus, it may be difficult to utilize the central space of the vehicle. In the case of electric vehicles, securing space for and freedom of placement of the motor and battery are important. If the central space of the vehicle is utilized, there may be a significant advantage in utilizing the underbody space of the vehicle.

### SUMMARY

In addition, with the known systems, it may be difficult to change the wheel tread, i.e., track width, vehicle track, or track, which means the distance between the left and right wheels of the vehicle, with the existing vehicle structure. This may cause problems in improvement of driving stability, changes in driving characteristics, and extension of tire life.

Aspects of the present disclosure are to provide a wheel control system and a method of controlling a wheel using the same, in which a wheel track of a vehicle may be increased or decreased.

Other aspects of the present disclosure are to provide a wheel control system and a method of controlling a wheel using the same, in which a camber, a toe, and/or wheel track of a vehicle may be controlled by utilizing a linear actuator in a double wishbone structure of the vehicle.

According to an aspect of the present disclosure, a wheel control system includes a wheel control device coupled to a wheel of a vehicle. The system also includes a control unit controlling the wheel control device. The wheel control device includes a first actuator arm and a second actuator arm separately provided from the first actuator arm. The wheel control device may also include a third actuator arm spaced apart from the first actuator arm and the second actuator arm. The wheel control system may also include two wheels disposed across a chassis of a vehicle, where each wheel is coupled to a separate wheel control device. The wheel control system may further include a separate control unit for each of the separate wheel control devices.

The wheel control system may further include a knuckle connected to the wheel control device and coupled to the wheel. The first actuator arm may include a first linear actuator connected to the knuckle and the second actuator arm may include a second linear actuator connected to the knuckle.

The knuckle may include a knuckle body, a first knuckle arm extending from the knuckle body, and a second knuckle arm extending from the knuckle body and spaced apart from the first knuckle arm. The first knuckle arm may be connected to the first actuator arm and the second knuckle arm may be connected to the second actuator arm.

The first actuator arm may further include a motor. The first linear actuator may include: a cylinder having a cylinder hole and extending from a chassis toward the knuckle; a piston capable of reciprocating in an extension direction of the cylinder in the cylinder hole; and a screw shaft positioned in the cylinder hole and connected to the piston. The motor may drive the piston through the screw shaft.

The first actuator arm may further include a proximity sensor for detecting a position of the piston.

The cylinder may have a groove through which a fluid is discharged from the cylinder hole.

According to an aspect of the present disclosure, a method of controlling a wheel includes an information collection operation for collecting vehicle information by a wheel control system. The method also includes a data calculation or obtaining operation for obtaining, determining, or calculating, by the wheel control system, wheel moving information using the vehicle information. The method further includes a wheel moving operation for moving the wheel by the wheel control system. The wheel moving operation changes a wheel track of a vehicle or changes an angle of the wheel by an actuator arm, such as a linear actuator connected to respective wheels in the wheel control system.

The vehicle information may include a speed of a vehicle. The data calculation operation may determine or calculate, by the wheel control system, a driving stability wheel track capable of improving driving safety of the vehicle. The wheel moving operation may change the wheel track according to the driving stability wheel track by extending or shortening the linear actuator by the wheel control system.

The vehicle information may include a speed of a vehicle. The data calculation operation may calculate a fuel efficiency improvement wheel track capable of improving a fuel efficiency of the vehicle. The wheel moving operation may change the wheel track according to the fuel efficiency improvement wheel track by extending or shortening the linear actuator by the wheel control system.

The vehicle information may include a driving speed of a vehicle and an angle of the wheel for a vehicle. The data calculation operation may calculate, by the wheel control system, a minimum wheel track at which the vehicle does not roll over. The wheel moving operation may change the wheel track according to the minimum wheel track by extending or shortening the linear actuator arms by the wheel control system.

The vehicle information may include a speed of the vehicle. The data calculation operation may calculate a fuel efficiency improvement wheel track capable of improving a fuel efficiency of the vehicle. The wheel moving operation may change the wheel track according to the fuel efficiency improvement wheel track by extending or shortening the linear actuator by the wheel control system.

The vehicle information may include a driving speed of a vehicle and an angle of the wheel for a vehicle. The data calculation operation may calculate, by the wheel control system, a minimum wheel track at which the vehicle does not roll over. The wheel moving operation may change the wheel track according to the minimum wheel track by extending or shortening the linear actuator by the wheel control system.

The vehicle information may include a degree of moisture of a road surface on which a vehicle is driving and a level of frictional force between the vehicle and the road surface. The data calculation operation may calculate, by the wheel control system, a minimum wheel track at which the vehicle will not slip on the road surface. The wheel moving operation may change the wheel track according to the minimum wheel track by extending or shortening the linear actuator by the wheel control system.

The wheel control system may include a first wheel control device connected to a first wheel of a vehicle and may include a second wheel control device connected to a second wheel of the vehicle and spaced apart from the first wheel control device. The wheel control system may also include a control unit for controlling the first wheel control device and the second wheel control device. In the wheel moving operation, the control unit may individually control the first wheel control device and the second wheel control device.

The vehicle information may include acceleration of the vehicle and an angle of the wheel for a vehicle. The data calculation operation may calculate, by the control unit, a minimum wheel track at which the vehicle will not roll over. The wheel moving operation may change a wheel track of the vehicle according to the minimum wheel track by extending or shortening linear actuators of the first wheel control device and the second wheel control device by the control unit.

The vehicle information may include an angle of the wheel for a vehicle and acceleration of the vehicle. The data calculation operation may calculate, by the control unit, a maximum camber capable of improving a grip of the vehicle when cornering. The wheel moving operation may change cambers of the first wheel and the second wheel according to the maximum camber by controlling the first wheel control device and the second wheel control device by the control unit.

The vehicle information may include an angle of the wheel for a vehicle and acceleration of the vehicle. The data calculation operation may calculate a minimum camber capable of improving driving safety of the vehicle when the vehicle is driving straight. The wheel moving operation may change cambers of the first wheel and the second wheel according to the minimum camber by controlling the first wheel control device and the second wheel control device by the control unit.

The first wheel control device may include a first actuator arm and a second actuator arm provided separately from the first actuator arm. The wheel moving operation may change a camber of the first wheel according to the minimum camber by extending the first actuator arm and shortening the second actuator arm by the control unit.

### BRIEF DESCRIPTION OF DRAWINGS

The above and other aspects, features, and advantages of the present disclosure should be more clearly understood from the following detailed description, taken in conjunction with the accompanying drawings, in which:

FIG. 1 is a perspective view illustrating a structure of a vehicle according to an embodiment;

FIG. 2 is a perspective view illustrating a wheel control system and a wheel according to an embodiment;

FIG. 3 is a plan view illustrating a wheel control system and a wheel according to an embodiment;

FIG. 4 is a front view illustrating a wheel control system and a wheel according to an embodiment;

FIG. 5 is a cross-sectional view illustrating an actuator arm and an arm auxiliary support according to an embodiment;

FIG. 6 is an enlarged cross-sectional view illustrating a portion of an actuator arm according to an embodiment;

FIG. 7 is an enlarged cross-sectional view illustrating a portion of an actuator arm according to an embodiment;

FIG. 8 is a flowchart illustrating a method of controlling a wheel according to an embodiment;

FIG. 9 is a front view illustrating a wheel control system and a wheel according to an embodiment;

FIG. 10 is a graph illustrating a wheel track based on a vehicle speed according to an embodiment;

FIG. 11 is a graph illustrating a wheel track based on a steering angle according to an embodiment;

FIG. 12 is a front view illustrating a wheel control system and a wheel according to an embodiment;

FIG. 13 is a front view illustrating a wheel control system and a wheel according to an embodiment;

FIG. 14 is a plan view illustrating a wheel control system and a wheel according to an embodiment; and

FIG. 15 is a plan view illustrating a wheel control system and a wheel according to an embodiment.

### DETAILED DESCRIPTION

The technical concepts of the present disclosure may have various modifications and various embodiments, though only specific embodiments are illustrated in the drawings and described in detail. However, this is not intended to limit the present disclosure to specific embodiments. It should be understood that all modifications, equivalents, and substitutes included in the spirit and technical scope of the present disclosure are included.

The terms first, second, and the like may be used to describe various components, but the components should not be limited by the terms. The terms are used only for the purpose of distinguishing one component from another. For example, without departing from the scope of the present disclosure, the first component may be referred to as the second component, and similarly, the second component may also be referred to as the first component. The term ‘and/or’ includes a combination of a plurality of related described items or any of a plurality of related described items.

The terms “-unit, -part, -portion, and the like” may be used to describe various components, but the components should not be limited by the terms. The above terms may refer to not only physically/visibly distinct configurations, but also to functions or configurations of corresponding parts, even if the distinction/division is not clearly defined.

The terms used in this application are used only to describe specific embodiments and are not intended to limit the present disclosure. The singular expression includes plural expressions unless the context clearly indicates otherwise. In this application, the terms “include,” “have” and the like should be understood to indicate the presence of features, numbers, steps, operations, components, parts, or combinations thereof described in the specification. However, such terms do not preclude the possibility of the presence or addition of one or more other features, numbers, steps, operations, components, parts, or combinations thereof.

Unless otherwise defined, all terms used herein, including technical or scientific terms, have the same meaning as generally understood by a person of ordinary skill in the art to which the present disclosure belongs. Terms that are defined in commonly used dictionaries should be interpreted as having a meaning consistent with the meaning they have in the context of the relevant technology. Such terms are not to be interpreted in an ideal or overly formal sense unless explicitly defined in this application.

In the description below, the terms “forward,” “backward,” “lateral,” “front,” “vertical,” “above,” “on,” “upper,” “below,” “lower,” “left and right,” and the like used in relation to direction are defined based on reference to a vehicle or a vehicle body. In addition, the terms first, second, and the like may be used to describe various components, but these components are not limited in terms of order, size, location, or importance by the terms first, second, and the like. Such components are named only for the purpose of distinguishing one component from another.

Hereinafter, with reference to the attached drawings, example embodiments are described in more detail. When a component, device, element, or the like of the present disclosure is described as having a purpose or performing an operation, function, or the like, the component, device, or element should be considered herein as being “configured to” meet that purpose or to perform that operation or function. The present disclosure describes various components of a wheel control system as control units or modules. Each of these units or the like may separately embody or be included with a processor and a memory, such as a non-transitory computer readable media, as part of the unit.

In the drawings, D1 may be referred to as a first direction, D2 intersecting the first direction D1 may be referred to as a second direction, and D3 respectively intersecting the first direction D1 and the second direction D2 may be referred to as a third direction. The first direction D1 may be referred to as an upward direction, and the direction opposite to the first direction D1 may be referred to as a downward direction. In addition, each of the second direction D2 and the third direction D3 may be referred to as a horizontal direction.

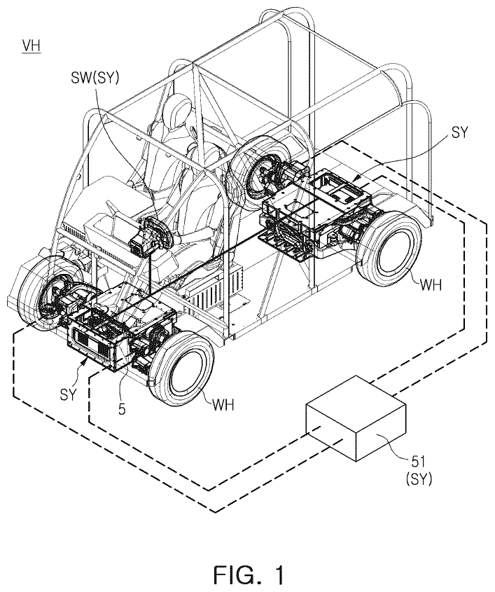

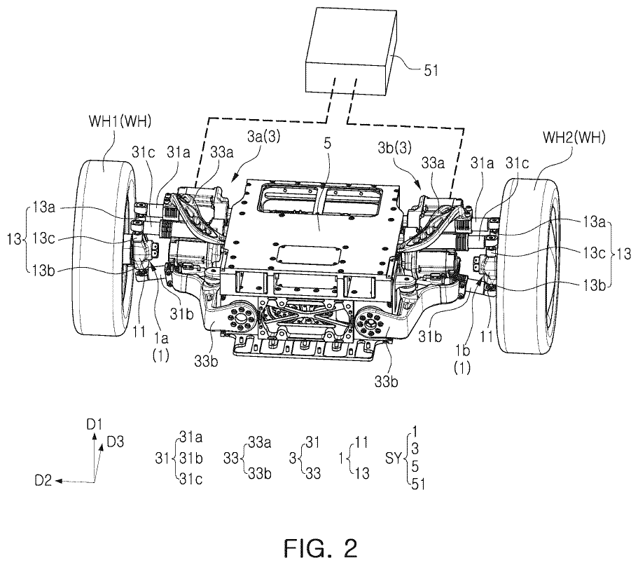

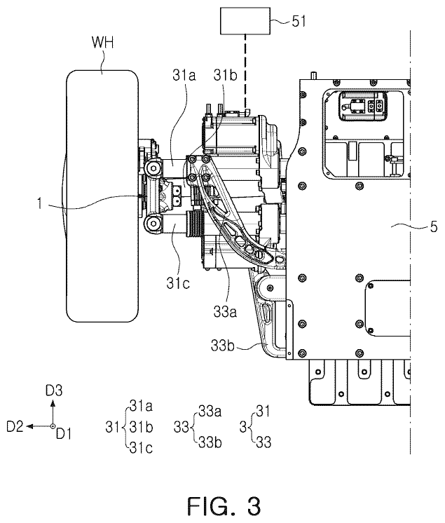

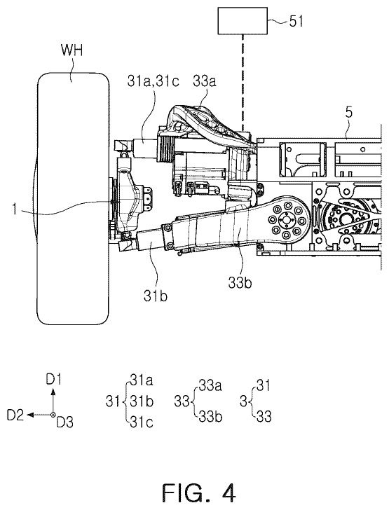

FIG. 1 is a perspective view illustrating the structure of a vehicle (VH) according to an embodiment. FIG. 2 is a perspective view illustrating a wheel control system (SY) and a wheel (WH) according to an embodiment. FIG. 3 is a plan view illustrating a wheel control system (SY) and a wheel (WH) according to an embodiment. FIG. 4 is a front view illustrating a wheel control system (SY) and a wheel (WH) according to an embodiment.

Referring to FIG. 1, a perspective view illustrating a vehicle according to an embodiment may be provided. The vehicle (VH) may include a wheel control system (SY) and a wheel (WH). In this specification, a wheel (WH) may refer to a tire, a rim and tire combination, or the like. In this specification, a plurality of wheels (WH) may be provided. For example, a first wheel WH1 may refer to a left front wheel. A second wheel WH2 may refer to a right front wheel. Hereinafter, a plurality of wheels (WH) may be described as a singular number. The contents applied to the wheel (WH) may also be applied to the first wheel WH1 and the second wheel WH2.

Referring to FIG. 1 and FIG. 2, the wheel control system (SY) according to an embodiment may include at least some of a knuckle 1, a wheel control device 3, and a control unit 51. The wheel control system (SY) may be connected to a chassis 5 of a vehicle.

The knuckle 1 may be provided as a plurality of knuckles. The plurality of knuckles 1 may be connected to respective wheels (WH). For example, a first knuckle 1a may be connected to the first wheel WH1. A second knuckle 1b may be connected to the second wheel WH2. In this specification, the plurality of knuckles 1 may be described as singular. The contents regarding the knuckle 1 may be applied to the first knuckle 1a and the second knuckle 1b.

The wheel control device 3 may be provided in plural. For example, the wheel control device 3 may include a first wheel control device 3a and a second wheel control device 3b. The first wheel control device 3a may be connected to the first wheel WH1 by the first knuckle 1a. The second wheel control device 3b may be connected to the second wheel WH2 by the second knuckle 1b. Hereinafter, the plurality of wheel control devices 3 may be described as a single unit. The description of the wheel control device 3 may be equally applied to the first wheel control device 3a and the second wheel control device 3b.

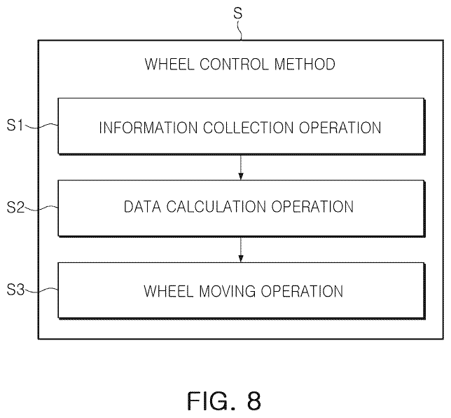

In this specification, the configuration of the front wheel of the vehicle (VH) and the configurations of the front wheel are illustrated, but the features and ideas of the present disclosure are not limited thereto. The contents of the wheel control system (SY) and a method (S) of controlling a wheel (see FIG. 8) using the same may also be applied to a wheel control device 3 connected to the rear wheels of the vehicle (VH). The contents of the wheel control system (SY) and the method (S) of controlling a wheel using the same may be applied to the wheel control device 3 connected to all wheels (WH) or each wheel (WH) included in the vehicle (VH).

The wheel control system (SY) according to an embodiment may further include a control unit 51. The control unit 51 may be located in the chassis 5, but is not limited thereto. The control unit 51 may be located at any location of the vehicle (VH). In this specification, for the convenience of description, the control unit 51 may be located in the chassis 5.

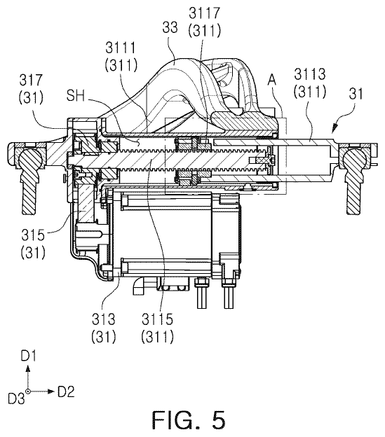

The control unit 51 may be electrically connected to the wheel control device 3. The control unit 51 may individually control a plurality of wheel control devices 3. In more detail, referring to FIGS. 1 and 2, the control unit 51 may individually control the first wheel control device 3a and the second wheel control device 3b. The control unit 51 may individually control actuator arms 31 of the plurality of wheel control devices 3 to operate a linear actuator 311 (refer to FIG. 5). Hereinafter, only a wheel control device 3 connected to one wheel (WH) may be illustrated and described in this specification. The control unit 51 may individually control all wheel control devices 3 included in the vehicle (VH). The role of the control unit 51 is described in detail below.

According to one embodiment, the control unit 51 may include at least one of a microprocessor, a microcontroller unit (MCU), a digital signal processor (DSP), a system on chip (SoC), an application processor, embedded memory, dynamic random access memory (DRAM), static random access memory (SRAM), electrically erasable programmable read-only memory (EEPROM), flash memory, ferroelectric random access memory (FRAM), magnetoresistive random access memory (MRAM), or non-volatile random access memory (NVRAM). However, the types of electronic components included in the control unit 51 are not limited thereto.

A wheel control system (SY) according to an embodiment may optionally further include some of a steering wheel (SW), a steering shaft, a gear box, and a steering feedback actuator (SFA).

The steering wheel (SW) may be a device directly operated by a driver to control the direction of a vehicle (VH). The driver may input a steering command by turning the steering wheel (SW). The steering wheel (SW) may control the wheel (WH) according to a steering ratio. The steering ratio may refer to a ratio of the rotation angles of the steering wheel (SW) and the wheel (WH). The lower the steering ratio, the more delicate or precise the steering may be.

The steering shaft may transmit the rotational motion of the steering wheel (SW) to the gear box. The steering shaft may be connected to the steering wheel (SW). The steering shaft may include a flexible structure to absorb energy in the event of a collision and protect the driver.

The gear box may transmit the rotational motion of the steering shaft to the wheel (WH) to rotate the wheel (WH). The gearbox may include various structures such as rack and pinion, recirculating ball, and worm and roller. The gearbox may transmit the rotational motion to the knuckle 1 to rotate the wheel.

The steering feedback actuator may provide feedback to the steering system of the vehicle. The steering feedback actuator may electronically transmit the road condition and steering response to the driver. The steering feedback actuator may obtain information from the steering wheel (SW) operated by the driver. The steering feedback actuator may be electrically connected to various sensors of the vehicle (VH). The sensors may collect data such as the angle of the vehicle wheel (WH), the driving speed of the vehicle (VH), and the road conditions. The steering feedback actuator may transmit the driving information of the vehicle (VH) collected by various sensors of the vehicle (VH) to the driver through the steering wheel (SW). The steering feedback actuator may calculate appropriate steering feedback and generate the required resistance or propulsion force to the steering wheel (SW) through an electric motor or a hydraulic system.

Hereinafter, the knuckle 1, the wheel control device 3, and the chassis 5 are described.

Referring to FIGS. 2, 3, and 4, the knuckle 1, the wheel control device 3, and the chassis 5 may be provided as part of the vehicle (VH).

The knuckle 1 may connect different configurations of the wheel (WH) and the vehicle (VH). The knuckle 1 may enable the steering and suspension operations of the vehicle (VH). The knuckle 1 may support the wheel (WH) to rotate and steer.

The knuckle 1 may be connected to the wheel control device 3. The wheel control device 3 and the wheel (WH) may be connected by the knuckle 1. The wheel control device 3 may control the direction of the wheel (WH) by controlling the knuckle 1. The knuckle 1 may transmit the movement of the suspension to the wheel (WH) and absorb the shock of the road surface by being connected to the wheel control device 3.

The knuckle 1 may include a knuckle body 11 and a knuckle arm 13 so as to be connected to the wheel control device 3. The knuckle arm 13 may extend from the knuckle body 11. The knuckle 1 may include a plurality of knuckle arms 13. For example, the knuckle 1 according to an embodiment may include a first knuckle arm 13a, a second knuckle arm 13b, and a third knuckle arm 13c. The first knuckle arm 13a, the second knuckle arm 13b, and the third knuckle arm 13c may be spaced apart from each other. The first knuckle arm 13a, the second knuckle arm 13b, and the third knuckle arm 13c may be extended in a Y shape from the knuckle body 11. Hereinafter, a plurality of knuckle arms 13 may be described as a single unit.

The chassis 5 may be included in the frame of the vehicle (VH). The chassis 5 may refer to any part of the frame. The frame may be the basic skeleton of the vehicle (VH) and may support major components such as an engine, a transmission, a suspension, and the like. However, the chassis 5 is not limited thereto, and may refer to a structure that supports auxiliary components of the vehicle (VH).

Inside the chassis 5, electronic devices and mechanical components may be located for driving of the vehicle (VH) and driver convenience. In more detail, various electronic control systems such as an anti-lock braking system (ABS), an electronic stability control (ESC), and an electronic suspension may be integrated inside the chassis 5, thereby providing for and improving safety and driving performance.

The wheel control device 3 may be connected to the knuckle 1. One side of the wheel control device 3 may be connected to the knuckle 1 to control the movement of the knuckle 1. The wheel control device 3 may be connected to the chassis 5. The other side of the wheel control device 3 may be connected to the chassis 5 and may be supported by the chassis 5.

Referring to FIG. 2, the first wheel control device 3a may be connected to one side of the chassis 5. The second wheel control device 3b may be connected to the other side of the chassis 5. The first wheel control device 3a and the second wheel control device 3b may be spaced apart from each other with the chassis 5 therebetween.

The wheel control device 3 may include an actuator arm 31. The wheel control device 3 may include a plurality of actuator arms 31. Hereinafter, in this specification, the plurality of actuator arms 31 may be described as a single unit. In more detail, the actuator arm 31 according to an embodiment may include a first actuator arm 31a, a second actuator arm 31b, and a third actuator arm 31c. However, the number of actuator arms 31 is not limited thereto. The first actuator arm 31a, the second actuator arm 31b, and the third actuator arm 31c may be spaced apart from each other. The wheel control device 3 may include two or fewer or four or more actuator arms 31. However, in this specification, the wheel control device 3 is described as including three actuator arms 31 in one embodiment.

In this specification, the first actuator arm 31a according to an embodiment may be located at the top. In this specification, the second actuator arm 31b according to an embodiment may be located below the first actuator arm 31a. In this specification, the third actuator arm 31c according to an embodiment may be located at the top but spaced forward or rearward of the first actuator arm 31a. The level of the first actuator arm 31a and the level of the third actuator arm 31c may be higher than the level of the second actuator arm 31b. However, the positional relationship of the first actuator arm 31a, the second actuator arm 31b, and the third actuator arm 31c is not limited thereto and may be interchanged. The description of the actuator arm 31 may be equally applied to the first actuator arm 31a, the second actuator arm 31b, and the third actuator arm 31c of any of the wheel control devices 3.

The first actuator arm 31a may be connected to the first knuckle arm 13a. In more detail, one side of the first actuator arm 31a may be connected to the first knuckle arm 13a. The other side of the first actuator arm 31a may be connected to the chassis 5. The first actuator arm 31a may be supported by the first knuckle arm 13a and the chassis 5.

The second actuator arm 31b may be connected to the second knuckle arm 13b. In more detail, one side of the second actuator arm 31b may be connected to the second knuckle arm 13b. The other side of the second actuator arm 31b may be connected to the chassis 5. The second actuator arm 31b may be supported by the second knuckle arm 13b and the chassis 5.

The third actuator arm 31c may be connected to the third knuckle arm 13c. In more detail, one side of the third actuator arm 31c may be connected to the third knuckle arm 13c. The other side of the third actuator arm 31c may be connected to the chassis 5. The third actuator arm 31c may be supported by the third knuckle arm 13c and the chassis 5.

Referring to FIGS. 2, 3, and 4, the wheel control device 3 according to an embodiment may further include an arm auxiliary support 33. The arm auxiliary support 33 may be coupled to the actuator arm 31. The arm auxiliary support 33 may connect the actuator arm 31 to the chassis 5 to increase the structural stability of the actuator arm 31.

The wheel control device 3 according to an embodiment may include a plurality of arm auxiliary supports 33. For example, the wheel control device 3 may include a first arm auxiliary support 33a and a second arm auxiliary support 33b. The plurality of arm auxiliary supports 33 may include a first arm auxiliary support 33a and a second arm auxiliary support 33b. In the present specification, a first actuator arm 31a according to an embodiment may be connected to the first arm auxiliary support 33a. The first actuator arm 31a may be connected to the chassis 5 by the first arm auxiliary support 33a. A second actuator arm 31b according to an embodiment may be connected to the second arm auxiliary support 33b. The second actuator arm 31b may be connected to the chassis 5 by the second arm auxiliary support 33b.

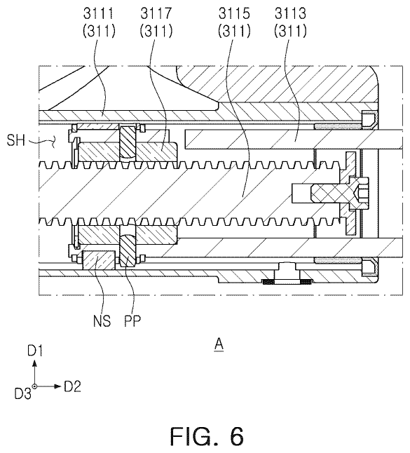

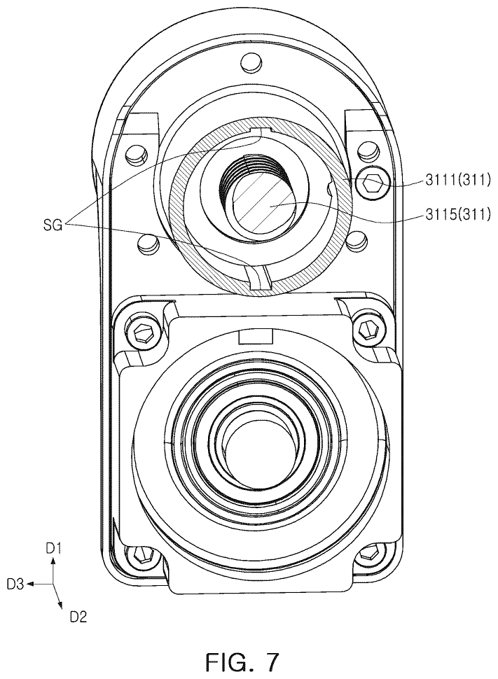

FIG. 5 is a cross-sectional view illustrating an actuator arm 31 and an arm auxiliary support 33 according to an embodiment. FIG. 6 is a cross-sectional view illustrating an enlarged section A of an actuator arm 31 according to an embodiment. FIG. 7 is a cross-sectional view illustrating an enlarged section of a portion of an actuator arm 31 according to an embodiment.

Hereinafter, the description of the actuator arm 31 is described based on the first actuator arm 31a for convenience. The description of the first actuator arm 31a may be equally applied to the second actuator arm 31b and the third actuator arm 31c.

Referring to FIG. 5, the actuator arm 31 according to an embodiment may include a linear actuator 311 and a motor 313. The actuator arm according to an embodiment may optionally include a belt 315 and a pulley 317. The linear actuator 311 may generate linear motion. The linear actuator 311 may include a hydraulic linear actuator, a pneumatic linear actuator, an electric linear actuator, or the like. However, the type of the linear actuator 311 is not limited thereto.

The hydraulic linear actuator may generate linear motion using a hydraulic system. The hydraulic linear actuator may provide strong force and torque.

The pneumatic linear actuator may generate linear motion using compressed air. The pneumatic linear actuator may have a fast response speed. The pneumatic linear actuator has a fast response speed and a simple structure, and may thus be used for light work.

The electric linear actuator may generate linear motion using an electric motor. The electric linear actuator may have high precision and controllability. The electric linear actuator may provide various speeds and forces.

In this specification, the linear actuator 311 included in the actuator arm 31 may be an electric linear actuator 311. However, this is only an example, and the type of the linear actuator 311 included in the actuator arm 31 is not limited thereto. The actuator arm 31 may include different types of linear actuators 311.

Each of the plurality of actuator arms 31 may include a linear actuator 311. In more detail, the first actuator arm 31a may include a first linear actuator. The second actuator arm 31b may include a second linear actuator. The third actuator arm 31c may include a third linear actuator.

The motor 313 may include an electric motor. The motor 313 may transmit rotational kinetic energy to the linear actuator 311 via a belt 315 and a pulley 317. The rotational kinetic energy of the motor 313 may be converted into linear kinetic energy of the linear actuator 311 via the belt 315 and the pulley 317.

Referring to FIG. 5, a linear actuator 311 according to an embodiment may include a cylinder 3111, a piston 3113, a screw shaft 3115, and a screw nut 3117.

The cylinder 3111 may be combined with other components of the actuator arm 31. The cylinder 3111 may extend from the chassis 5 toward the knuckle 1. The cylinder 3111 may extend in a second direction D2. The cylinder 3111 may have a cylinder bore or hole (SH) therein. The screw shaft 3115 and the pulley 317 may be positioned in the cylinder hole (SH). The pulley 317 may be connected to the belt 315 to change the driving direction of the belt 315. The screw shaft 3115 may provide a path along which the piston 3113 moves in a straight line. The screw shaft 3115 may be extended in the second direction D2. The screw shaft 3115 may be connected to the piston 3113. The piston 3113 may reciprocate in the second direction D2 by the screw shaft 3115. The screw shaft 3115 may be connected to the motor 313 by the belt 315 and the pulley 317.

The motor 313 may transfer rotational kinetic energy to the screw shaft 3115. The motor 313 may be connected to the screw shaft 3115 by the belt 315. When the motor 313 operates, the belt 315 moves and transfers the rotational kinetic energy of the motor 313 to the screw shaft 3115. The screw shaft 3115 may be rotated by the motor 313.

Referring to FIG. 6, the piston 3113 may be coupled with the cylinder 3111. The piston 3113 may perform a linear motion by the motor 313 and the screw shaft 3115. At least a portion of the piston 3113 may be positioned in the cylinder hole (SH). The piston 3113 according to an embodiment may be coupled with the screw nut 3117. The piston 3113 and the screw nut 3117 may be coupled by a screw fixing pin (PP). The piston 3113 may be connected to the screw shaft 3115 by the screw nut 3117. When the screw shaft 3115 rotates, the screw nut 3117 may move in the extension direction of the screw shaft 3115 to drive the piston 3113. Therefore, the rotational kinetic energy of the motor 313 may be converted into the linear kinetic energy of the piston through the screw shaft 3115.

The control unit 51 may control the wheel control device 3. The control unit 51 may be electrically connected to the motor 313. The control unit 51 may determine, obtain, or calculate the moving information of the wheel (WH) based on the driving information of the vehicle (VH). The control unit 51 may control the rotational direction and rotational speed of the motor 313 and the like based on the moving information of the wheel (WH). By changing the rotational direction and rotational speed of the motor 313, the driving speed, driving direction and position of the piston 3113, and the like may be controlled.

The control unit 51 may individually control a plurality of actuator arms 31 of the wheel control device 3. In more detail, the control unit 51 may individually control the first actuator arm 31a, the second actuator arm 31b, and the third actuator arm 31c.

Referring to FIG. 6, the actuator arm 31 according to an embodiment may further include a proximity sensor (NS). The proximity sensor (NS) may detect the position of the piston 3113. The proximity sensor (NS) may include an inductive proximity sensor, a capacitive proximity sensor, an ultrasonic proximity sensor, an optical proximity sensor, a magnetic proximity sensor, or the like. The inductive proximity sensor may detect an induced current flowing in a coil inside the proximity sensor. The capacitive proximity sensor may detect a change in capacitance between the proximity sensor and the detection target. The ultrasonic proximity sensor may measure the position of the detection target by emitting ultrasonic waves and receiving the reflected signal. The optical proximity sensor may emit light and detect the reflected light. The magnetic proximity sensor may detect the change in the magnetic field to determine the position of the detection target. However, the type of the proximity sensor (NS) is not limited thereto.

The proximity sensor (NS) may be electrically connected to the control unit 51. The proximity sensor (NS) may transmit the position of the piston 3113 to the control unit 51. The control unit 51 may control the actuator arm 31 based on the information received from the proximity sensor (NS).

Referring to FIG. 7, a cross-sectional view of a cylinder 3111 according to an embodiment may be provided along a plane perpendicular to the extension direction of the cylinder 3111. The cylinder 3111 according to an embodiment may include a groove (SG). Air in the cylinder hole (SH) may be discharged to the outside through the groove (SG). Air outside the cylinder 3111 may be introduced into the cylinder hole (SH) through the groove (SG).

FIG. 8 is a flowchart illustrating a method (S) of controlling a wheel according to an embodiment.

Referring to FIG. 8, a method (S) of controlling a wheel may include an information collection operation (S1) in which the wheel control system collects vehicle information including driving information. The method (S) may also include a data determination, obtaining, or calculation operation (S2) in which the wheel control system (SY) determines, obtains, or calculates moving information of the wheel (WH) using the vehicle information. The method (S) may also include a wheel moving operation (S3) in which the wheel control system (SY) moves the wheel. The wheel moving operation (S3) may change the wheel track or the steering angle of the wheel by the linear actuator 311 connected to respective wheels (WH) by the wheel control system (SY).

The vehicle information may include various data indicating the status of the vehicle (VH) and the driving situation of the vehicle (VH). For example, the vehicle information may include the speed, acceleration, driving distance, engine RPM, engine temperature, tire pressure, road condition, a road humidity degree, a friction level between the vehicle (VH) and the road, suspension height, suspension strength, angle of the vehicle wheel (WH), camber, toe, wheel track of the vehicle (VH), and the like. However, the vehicle or driving information of the vehicle (VH) is not limited thereto.

The vehicle information may be obtained from electronic equipment including various sensors of the vehicle (VH). For example, the speed of the vehicle (VH) may be calculated using a wheel speed sensor or a global positioning system (GPS). The steering angle of the vehicle (VH) may be obtained using a Steering Angle Sensor (SAS). The control unit 51 may receive vehicle information from various electronic devices of the vehicle (VH).

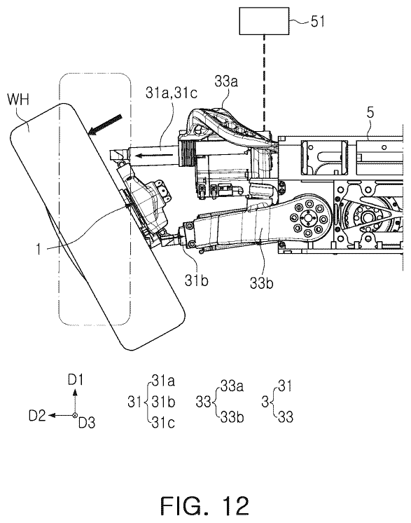

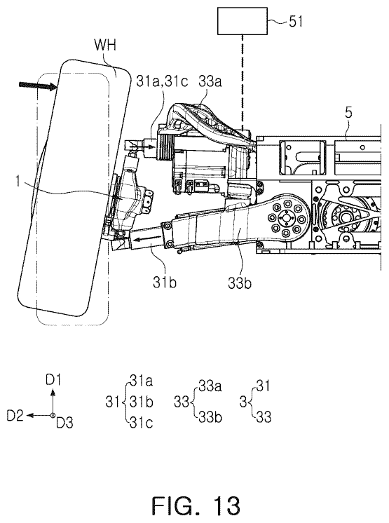

Referring to FIGS. 12 and 13, the camber may refer to the angle at which the wheel (WH) is tilted when viewed from the front or rear of the vehicle (VH). As illustrated in FIG. 12, if the upper part of the wheel (WH) is away from the center of the vehicle (VH), it may be referred to as positive camber. If the upper part of the wheel (WH) is tilted toward the center of the vehicle (VH), it may be referred to as negative camber. When the upper part of the wheel (WH) is away from the center of the vehicle (VH), the camber may be said to increase. If the upper part of the wheel (WH) is tilted toward the center of the vehicle (VH), the camber may be said to decrease.

As the camber of the wheel (WH) increases, the safety when driving straight may be increased. As the camber of the wheel (WH) decreases, safety when cornering may be increased.

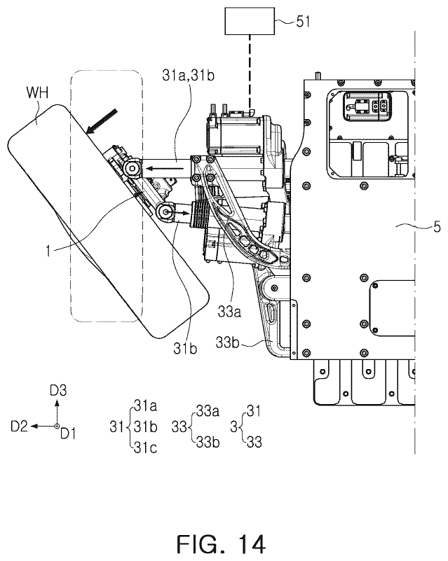

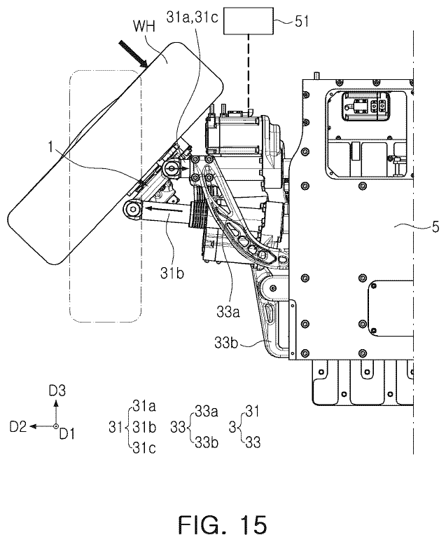

Referring to FIGS. 14 and 15, the toe may refer to the degree to which the wheel (WH) is tilted with respect to the longitudinal axis of the vehicle (VH) when viewed from above the vehicle (VH). Referring to FIG. 14, when the front of the wheel (WH) is directed toward the outside of the vehicle (VH), it may be called toe-out. Referring to FIG. 15, when the front of the wheel (WH) is directed toward the inside of the vehicle (VH), it may be called toe-in.

The more toe-in occurs, the more the straight-line safety of the vehicle (VH) may be increased. The more toe-out occurs, the more the handling and responsiveness of the vehicle (VH) may be improved.

Wheel track may refer to the horizontal distance between two wheels (WH) on the same widthwise axis or axle of the vehicle (VH). The distance between the front wheels may be referred to the front track. The distance between the rear wheels may be referred to the rear track.

A wide wheel track may increase the stability of the vehicle (VH). When the wheel track is relatively wide, the body of the vehicle (VH) tilts less when cornering, thereby providing improved grip.

The driving information of the vehicle (VH) may be collected through various sensors inside or outside the vehicle (VH). The control unit 51 may calculate the driving information of the wheel (WH) using the driving information of the vehicle (VH) obtained from various sensors. The control unit 51 may change the driving information of the vehicle (VH) by controlling the wheel control device 3 using the driving information of the wheel (WH). For example, the control unit 51 may change the wheel track, camber, and toe by controlling the wheel control device 3.

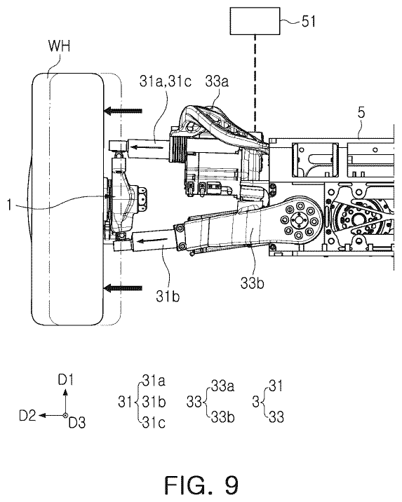

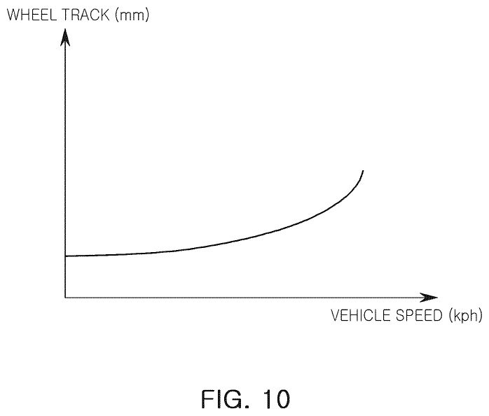

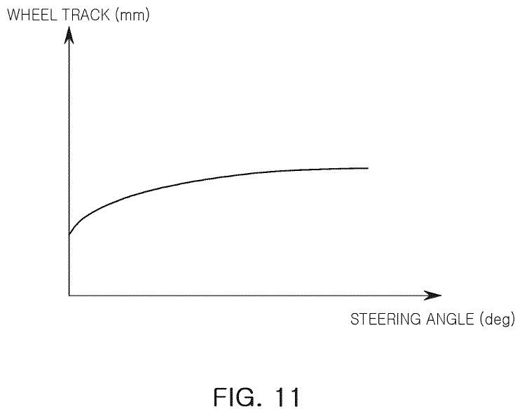

FIG. 9 is a front view illustrating a wheel control system (SY) and a wheel (WH) according to an embodiment. FIG. 10 is a graph illustrating a wheel track according to a vehicle speed according to an embodiment. FIG. 11 is a graph illustrating a wheel track according to a steering angle according to an embodiment.

Referring to FIG. 9, the wheel track may increase as all the actuator arms 31 are extended. The control unit 51 may increase the wheel track by extending the first actuator arm 31a, the second actuator arm 31b, and the third actuator arm 31c. Conversely, the control unit 51 may decrease the wheel track by shortening the first actuator arm 31a, the second actuator arm 31b, and the third actuator arm 31c.

Referring to FIG. 10, a graph illustrating wheel track according to vehicle speed required for stable driving may be provided. The horizontal axis of the graph may refer to vehicle speed. The vertical axis of the graph may refer to wheel track. As the vehicle (VH) drives at a high speed, the wheel track may need to increase for stable driving.

Referring to FIG. 11, a graph illustrating wheel track according to steering angle required for stable cornering may be provided. The horizontal axis of the graph may refer to steering angle. The vertical axis of the graph may refer to wheel track. As the steering angle of the vehicle (VH) increases, the wheel track may need to increase for the vehicle (VH) to not overturn.

In this manner, for stable driving of the vehicle (VH), the wheel control system (SY) may change the wheel track of the vehicle (VH) by controlling the wheel control device 3 using the control unit 51.

Referring to FIGS. 8, 9, and 10, in the data calculation operation (S2), the wheel control system 3 may determine or calculate a driving stability wheel track that may improve, i.e., increase the driving safety of the vehicle (VH) when the vehicle (VH) is driving at high speed. At this time, in the wheel moving operation (S3), the wheel control system (SY) may change the wheel track according to the driving stability wheel track by extending or retracting the actuator arm 31. The wheel control system (SY) may change the wheel track according to the driving stability wheel track by extending or retracting the linear actuator 311.

In the data calculation operation (S2), the wheel control system 3 may determine or calculate a fuel efficiency improvement wheel track that may improve the fuel efficiency of the vehicle (VH). At this time, in the wheel moving operation (S3), the wheel control system (SY) may change the wheel track according to the fuel efficiency improvement wheel track by extending or retracting the actuator arm 31. The wheel control system (SY) may change the wheel track according to the fuel efficiency improvement wheel track by extending or retracting the linear actuator 311.

Referring to FIG. 8, FIG. 9 and FIG. 11, in the data calculation operation (S2), the wheel control system 3 may calculate a minimum wheel track that prevents the vehicle (VH) from slipping or overturning. At this time, in the wheel moving operation (S3), the wheel control system (SY) may change the wheel track according to the minimum wheel track by extending or retracting the actuator arm 31. The wheel control system (SY) may change the wheel track according to the minimum wheel track by extending or retracting the linear actuator 311.

FIG. 12 is a front view illustrating a wheel control system (SY) and a wheel (WH) according to an embodiment, FIG. 13 is a front view illustrating a wheel control system (SY) and a wheel (WH) according to an embodiment, FIG. 14 is a plan view illustrating a wheel control system (SY) and a wheel (WH) according to an embodiment, and FIG. 15 is a plan view illustrating a wheel control system (SY) and a wheel (WH) according to an embodiment.

The wheel control system (SY) may change more than just the wheel track for driving the vehicle (VH). For example, the wheel control system (SY) may change the camber or toe by driving the wheel control device 3 by the control unit 51.

Referring to FIGS. 12, 13, 14, and 15, the control unit 51 may change the camber and toe by individually changing the extension direction of the actuator arm 31.

Referring to FIGS. 12 and 13, the control unit 51 may increase the camber by extending the first actuator arm 31a and the third actuator arm 31c and shortening the second actuator arm 31b. Conversely, the control unit 51 may decrease the camber by shortening the first actuator arm 31a and the third actuator arm 31c and extending the second actuator arm 31b.

Referring to FIGS. 8, 12 and 13, in the data calculation operation (S2), the control unit 51 may determine or calculate a maximum camber that may improve, i.e., increase the grip of the vehicle (VH) when cornering. In the wheel moving operation (S3), the control unit 51 may change the camber of the wheel (WH) according to the maximum camber by controlling the wheel control device 3. The control unit 51 may individually control a plurality of actuator arms 31 of the wheel control device 3 to change the camber of the wheel (WH) to improve the grip of the wheel (WH).

Referring to FIG. 8, FIG. 12, and FIG. 13, in the data calculation operation (S2), the control unit 51 may determine or calculate a minimum camber that may improve the driving safety of the vehicle (VH). In the wheel moving operation (S3), the control unit 51 may control the wheel control device 3 to change the camber of the wheel (WH) according to the minimum camber. The control unit 51 may individually control a plurality of actuator arms 31 of the wheel control device 3 to change the camber of the wheel (WH) to improve the driving safety of the vehicle (VH).

Referring to FIGS. 14 and 15, the control unit 51 may increase the toe by shortening the third actuator arm 31c and extending the first actuator arm 31a and the second actuator arm 31b. Conversely, the control unit 51 may decrease the toe by extending the third actuator arm 31c and shortening the first actuator arm 31a and the second actuator arm 31b.

However, the movement of the wheel control device 3 is not limited thereto. The wheel control device 3 may change the driving performance and information of the vehicle (VH) or may be varied in various manners according to the driver's intention.

According to a wheel control system (SY) and a method (S) of controlling a wheel using the same of the example embodiments, the driving safety of the vehicle (VH) may be improved. For example, when the wheel track becomes wider during driving at high speed, the driving stability of the vehicle (VH) may be improved, i.e., increased. Also, when it snows or rains, the wider the wheel track becomes, the more stable the driving is, allowing the driver to respond safely to changing road conditions.

In addition to the wheel track, the wheel control system (SY) may improve the wheel grip when cornering by reducing the camber. The wheel control system (SY) may provide improved handling performance by reducing the camber. Also, when the vehicle (VH) is driving straight, the wheel control system (SY) may increase the camber to improve, i.e., increase straight-line stability.

The wheel control system (SY) may improve handling and responsiveness by generating toe-out, allowing the vehicle (VH) to change direction more quickly. Also, the wheel control system (SY) may improve straight-line stability by generating toe-in. The wheel control system (SY) may improve the fixation of the wheel (WH) during driving by generating toe-in.

According to a wheel control system (SY) and a method (S) of controlling a wheel using the same of the example embodiments, the economy of driving a vehicle (VH) may be improved. In the case in which the wheel track increases, air resistance increases during high-speed driving of the vehicle (VH), which may increase fuel consumption. The wheel control system (SY) may increase fuel efficiency by reducing the wheel track.

In addition, the wheel control system (SY) may increase the life of the tires by changing the wheel track, camber, and toe. If the wheel track is increased, the gripping force may be improved, which may increase the tire wear rate. The more toe-out occurs, the higher the wear rate of the inner area of the wheel (WH). The lower the camber, the higher the wear rate of the inner area of the wheel (WH). The wheel control system (SY) may reduce the wear rate of the tire by controlling the wheel track, toe, and camber to an appropriate level.

As set forth above, a wheel control system according to an embodiment and a method of controlling a wheel using the same may increase or decrease a wheel track of a vehicle.

A wheel control system according to an embodiment and a method of controlling a wheel using the same may control a camber, a toe, or a wheel track of a vehicle by utilizing a linear actuator in a double wishbone structure of the vehicle.

While example embodiments have been illustrated and described above, it should be apparent to those of ordinary skill in the art that modifications and variations could be made without departing from the scope of the present disclosure as defined by the appended claims.

What is claimed is:

1. A wheel control system comprising:
a wheel control device configured to be coupled to a wheel on a vehicle; and
a control unit controlling the wheel control device,
wherein the wheel control device includes
a first actuator arm,
a second actuator arm separately provided from the first actuator arm, and
a third actuator arm spaced apart from the first actuator arm and the second actuator arm.

2. The wheel control system of claim 1, further comprising a knuckle connected to the wheel control device and coupled to the wheel
wherein the first actuator arm includes a first linear actuator connected to the knuckle,
the second actuator arm includes a second linear actuator connected to the knuckle, and
the third actuator arm includes a third linear actuator connected to the knuckle.

3. The wheel control system of claim 2, wherein the knuckle includes:
a knuckle body;
a first knuckle arm extending from the knuckle body;
a second knuckle arm extending from the knuckle body and spaced apart from the first knuckle arm; and
a third knuckle arm spaced apart from the first knuckle arm and the second knuckle arm,
wherein the first knuckle arm is connected to the first actuator arm,
the second knuckle arm is connected to the second actuator arm, and
the third knuckle arm is connected to the third actuator arm.

4. The wheel control system of claim 2, wherein:
the first actuator arm further includes a motor;
the first linear actuator includes
a cylinder having a cylinder hole and configured to extend from a chassis of a vehicle toward the knuckle,
a piston configured to reciprocate in an extension direction of the cylinder in the cylinder hole, and
a screw shaft positioned in the cylinder hole and connected to the piston; and
the motor is configured to drive the piston through the screw shaft.

5. The wheel control system of claim 4, wherein the first actuator arm further includes a proximity sensor configured to detect a position of the piston.

6. The wheel control system of claim 4, wherein the cylinder has a groove through which a fluid is discharged from the cylinder hole.

7. The wheel control system of claim 1, wherein:
the wheel control device includes two wheel control devices, one each coupled to a corresponding wheel on each side of a vehicle; and
the control unit includes two control units, one each configured to control a respective one of the two wheel control devices,
wherein each of the two wheel control devices includes one of the first actuator arms, one of the second actuator arms, and one of the third actuator arms.

8. A method of controlling a wheel of a vehicle, the method comprising:
collecting, by a wheel control system, vehicle information of the vehicle;
determining, by the wheel control system, wheel moving information using the vehicle information; and
moving the wheel by the wheel control system,
wherein moving the wheel changes, by actuator arms of the wheel control system, a wheel track of the vehicle or changes an angle of the wheel by the actuator arms connected to the wheel.

9. The method of claim 8, wherein:
the vehicle information includes a speed of the vehicle;
the method further includes determining, by the wheel control system, a driving stability wheel track configured to increase driving safety of the vehicle; and
moving the wheel changes the wheel track according to the driving stability wheel track by extending or shortening the actuator arms by the wheel control system.

10. The method of claim 8, wherein:
the vehicle information includes a speed of the vehicle;
the method further includes determining a fuel efficiency improvement wheel track configured to increase a fuel efficiency of the vehicle; and
moving the wheel changes the wheel track according to the fuel efficiency improvement wheel track by extending or shortening the actuator arms by the wheel control system.

11. The method of claim 8, wherein:
the vehicle information includes a driving speed of the vehicle and an angle of the wheel for the vehicle;
the method further includes determining, by the wheel control system, a minimum wheel track at which the vehicle does not roll over; and
moving the wheel changes the wheel track according to the minimum wheel track by extending or shortening one or more of the actuator arms by the wheel control system.

12. The method of claim 8, wherein:
the vehicle information includes a degree of moisture of a road surface on which the vehicle is driving and a level of frictional force between the vehicle and the road surface;
the method further includes determining, by the wheel control system, a minimum wheel track at which the vehicle does not slip relative to the road surface; and
moving the wheel changes the wheel track according to the minimum wheel track by extending or shortening one or more of the actuator arms by the wheel control system.

13. The method of claim 8, wherein the wheel control system includes:
a first wheel control device having the actuator arms connected to a first wheel of a vehicle;
a second wheel control device having further actuator arms connected to a second wheel of the vehicle and spaced apart from the first wheel control device; and
a control unit controlling the first wheel control device and the second wheel control device,
wherein moving the wheel includes individually controlling the first wheel control device and the second wheel control device by the control unit.

14. The method of claim 13, wherein:
the vehicle information includes acceleration of the vehicle and an angle of the first wheel and the second wheel of the vehicle;
the method further includes determining, by the control unit, a minimum wheel track at which the vehicle does not roll over; and
moving the wheel changes, by the control unit, a wheel track of the vehicle between the first and second wheels according to the minimum wheel track by extending or shortening one or more of the actuator arms of the first wheel control device, one or of the further actuator arms of the second wheel control device, or both.

15. The method of claim 13, wherein:
the vehicle information includes acceleration of the vehicle and an angle of the first wheel and the second wheel of the vehicle;
the method further includes determining, by the control unit, a maximum camber capable of increasing a grip of the vehicle when cornering; and
moving the wheel changes, by the control unit, cambers of the first wheel and the second wheel according to the maximum camber by controlling the first wheel control device and the second wheel control device.

16. The method of claim 13, wherein:
the vehicle information includes acceleration of the vehicle and an angle of the first wheel and the second wheel of the vehicle;
the method further includes determining, a minimum camber configured to increase driving safety of the vehicle when the vehicle is driving straight; and
moving the wheel changes, by the control unit, cambers of the first wheel and the second wheel according to the minimum camber by controlling the first wheel control device and the second wheel control device.

17. The method of claim 16, wherein the first wheel control device includes:
a first actuator arm; and
a second actuator arm provided separately from the first actuator arm,
wherein moving the wheel changes, by the control unit, a camber of the first wheel according to the minimum camber by extending the first actuator arm and shortening the second actuator arm.

18. The method of claim 13, wherein the actuator arms and the further actuator arms each include a first actuator arm, a second actuator arm, and a third actuator arm.
